(19) United States
(12) Patent Application Publication
(10) Pub. No.: US 2018/0263059 A1
(43) Pub. Date: Sep. 13, 2018

(54) METHOD, SYSTEM AND APPARATUS FOR DETERMINING PHYSICAL RANDOM ACCESS CHANNEL RESOURCES

(71) Applicant: NOKIA SOLUTIONS AND NETWORKS OY, Espoo (FI)

(72) Inventors: Claudio ROSA, Randers NV (DK); Frank FREDERIKSEN, Klarup (DK)

(73) Assignee: Nokia Solutions and Networks OY, Espoo (FI)

(21) Appl. No.: 15/760,711

(22) PCT Filed: Sep. 14, 2016
(86) PCT No.: PCT/EP2016/071615

§ 371 Date: Mar. 16, 2018

(30) Foreign Application Priority Data
Sep. 18, 2015 (EP) PCT/EP2015/071484

(51) Int. Cl. H04W 74/08; H04L 5/00

(52) U.S. Cl. CPC H04W 74/0833; H04L 5/0048

(57) ABSTRACT

There is provided a method comprising receiving a reference signal from an access point of a cell, wherein the transmission of the reference signal is indicative of the availability of the physical random access channel resources, determining timing of physical random access channel resources in dependence on the timing of the reference signal and causing transmission of a physical random access signal using the physical random access channel resources.

### FIELD

The present application relates to a method, apparatus, system and computer program and in particular but not exclusively to standalone operation in unlicensed spectrum.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. An example of attempts to solve the problems associated with the increased demands for capacity is an architecture that is known as the long-term evolution (LTE) of the Universal Mobile Telecommunications System (UMTS) radio-access technology. The LTE is being standardized by the 3rd Generation Partnership Project (3GPP). The various development stages of the 3GPP LTE specifications are referred to as releases. Certain releases of 3GPP LTE (e.g., LTE Rel-11, LTE Rel-12, LTE Rel-13) are targeted towards LTE-Advanced (LTE-A). LTE-A is directed towards extending and optimising the 3GPP LTE radio access technologies.

### SUMMARY

In a first aspect there is provided a method comprising receiving a reference signal from an access point of a cell, wherein the transmission of the reference signal is indicative of the availability of the physical random access channel resources, determining timing of physical random access channel resources in dependence on the timing of the reference signal and causing transmission of a physical random access signal using the physical random access channel resources.

The method may comprise receiving physical random access channel configuration information.

The physical random access channel configuration information may comprises at least one of frequency information and preamble sequence information.

The method may comprise receiving information indicating the relation between the timing of the reference signal and the timing of physical random access channel resources.

The method may comprise causing the transmission of the physical random access signal in dependence on the outcome of a clear channel assessment procedure.

The method may comprise causing transmission of the physical random access signal without performing a clear channel assessment procedure.

The method may comprise receiving information from the access point indicating whether to perform the clear channel assessment procedure.

The method may comprise receiving a second reference signal and causing the transmission of the physical random access signal after receipt of the second reference signal.

The reference signal may be a discovery reference signal.

The physical random access signal may be a physical random access channel preamble.

In a second aspect there is provided a method comprising providing a reference signal, for use in determining timing of physical random access channel resources, wherein the transmission of the reference signal is indicative of the availability of the physical random access channel resources and receiving, from a user device, transmission of a physical random access signal using the physical random access channel resources.

The method may comprise providing physical random access channel configuration information to the user device.

The physical random access channel configuration information may comprise at least one of frequency information and preamble sequence information.

The method may comprise providing information indicating the relation between the timing of the reference signal and the timing of physical random access channel resources.

The method may comprise receiving transmission of the physical random access signal in dependence on the outcome of a clear channel assessment procedure.

The method may comprise receiving transmission of the physical random access signal without performing a clear channel assessment procedure.

The method may comprise providing an indication to the user device to perform a clear channel assessment procedure.

The method may comprise causing transmission of a second reference signal and receiving the transmission of the physical random access signal after causing transmission of the second reference signal.

The reference signal may be a discovery reference signal.

The physical random access signal may be a physical random access channel preamble.

In a third aspect there is provided an apparatus, said apparatus comprising means for receiving a reference signal from an access point of a cell, wherein the transmission of the reference signal is indicative of the availability of the physical random access channel resources, determining timing of physical random access channel resources in dependence on the timing of the reference signal and causing transmission of a physical random access signal using the physical random access channel resources.

The apparatus may comprise means for receiving physical random access channel configuration information.

The physical random access channel configuration information may comprise at least one of frequency information and preamble sequence information.

The apparatus may comprise means for receiving information indicating the relation between the timing of the reference signal and the timing of physical random access channel resources.

The apparatus may comprise means for causing the transmission of the physical random access signal in dependence on the outcome of a clear channel assessment procedure.

The apparatus may comprise means for causing transmission of the physical random access signal without performing a clear channel assessment procedure.

The apparatus may comprise means for receiving information from the access point indicating whether to perform the clear channel assessment procedure.

The apparatus may comprise means for receiving a second reference signal and means for causing the transmission of the physical random access signal after receipt of the second reference signal.

The reference signal may be a discovery reference signal.

The physical random access signal may be a physical random access channel preamble.

In a fourth aspect there is provided an apparatus, said apparatus comprising means for providing a reference signal, for use in determining timing of physical random access channel resources, wherein the transmission of the reference signal is indicative of the availability of the physical random access channel resources and receiving, from a user device, transmission of a physical random access signal using the physical random access channel resources.

The apparatus may comprise means for providing physical random access channel configuration information to the user device.

The physical random access channel configuration information may comprise at least one of frequency information and preamble sequence information.

The apparatus may comprise means for providing information indicating the relation between the timing of the reference signal and the timing of physical random access channel resources.

The apparatus may comprise means for receiving transmission of the physical random access signal in dependence on the outcome of a clear channel assessment procedure.

The apparatus may comprise means for receiving transmission of the physical random access signal without performing a clear channel assessment procedure.

The apparatus may comprise means for providing an indication to the user device to perform a clear channel assessment procedure.

The apparatus may comprise means for causing transmission of a second reference signal and means for receiving the transmission of the physical random access signal after causing transmission of the second reference signal.

The reference signal may be a discovery reference signal.

The physical random access signal may be a physical random access channel preamble.

In a fifth aspect there is provided an apparatus comprising at least one processor and at least one memory including a computer program code, the at least one memory and the computer program code configured to, with the at least one processor, cause the apparatus at least to receive a reference signal from an access point of a cell, wherein the transmission of the reference signal is indicative of the availability of the physical random access channel resources, determine timing of physical random access channel resources in dependence on the timing of the reference signal and cause transmission of a physical random access signal using the physical random access channel resources.

The apparatus may be configured to receive physical random access channel configuration information.

The physical random access channel configuration information may comprise at least one of frequency information and preamble sequence information.

The apparatus may be configured to receive information indicating the relation between the timing of the reference signal and the timing of physical random access channel resources.

The apparatus may be configured to cause the transmission of the physical random access signal in dependence on the outcome of a clear channel assessment procedure.

The apparatus may be configured to cause transmission of the physical random access signal without performing a clear channel assessment procedure.

The apparatus may be configured to receive information from the access point indicating whether to perform the clear channel assessment procedure.

The apparatus may be configured to receive a second reference signal and cause the transmission of the physical random access signal after receipt of the second reference signal.

The reference signal may be a discovery reference signal.

The physical random access signal may be a physical random access channel preamble.

In a sixth aspect there is provided an apparatus comprising at least one processor and at least one memory including a computer program code, the at least one memory and the computer program code configured to, with the at least one processor, cause the apparatus at least to provide a reference signal, for use in determining timing of physical random access channel resources, wherein the transmission of the reference signal is indicative of the availability of the physical random access channel resources and receive, from a user device, transmission of a physical random access channel signal using the physical random access channel resources.

The apparatus may be configured to provide physical random access channel configuration information to the user device.

The physical random access channel configuration information may comprise at least one of frequency information and preamble sequence information.

The apparatus may be configured to provide information indicating the relation between the timing of the reference signal and the timing of physical random access channel resources.

The apparatus may be configured to receive transmission of the physical random access signal in dependence on the outcome of a clear channel assessment procedure.

The apparatus may be configured to receive transmission of the physical random access signal without performing a clear channel assessment procedure.

The apparatus may be configured to provide an indication to the user device to perform a clear channel assessment procedure.

The apparatus may be configured to cause transmission of a second reference signal and receive the transmission of the physical random access signal after causing transmission of the second reference signal.

The reference signal may be a discovery reference signal.

The physical random access signal may be a physical random access channel preamble.

In a seventh aspect, there is provided a computer program embodied on a non-transitory computer-readable storage medium, the computer program comprising program code for controlling a process to execute a process, the process comprising receiving a reference signal from an access point of a cell, wherein the transmission of the reference signal is indicative of the availability of the physical random access channel resources, determining timing of physical random access channel resources in dependence on the timing of the reference signal and causing transmission of a physical random access signal using the physical random access channel resources.

The process may comprise receiving physical random access channel configuration information.

The physical random access channel configuration information may comprises at least one of frequency information and preamble sequence information.

The process may comprise receiving information indicating the relation between the timing of the reference signal and the timing of physical random access channel resources.

The process may comprise causing the transmission of the physical random access signal in dependence on the outcome of a clear channel assessment procedure.

The process may comprise causing transmission of the physical random access signal without performing a clear channel assessment procedure.

The process may comprise receiving information from the access point indicating whether to perform the clear channel assessment procedure.

The process may comprise receiving a second reference signal and causing the transmission of the physical random access signal after receipt of the second reference signal.

The reference signal may be a discovery reference signal.

The physical random access signal may be a physical random access channel preamble.

In an eighth aspect, there is provided a computer program embodied on a non-transitory computer-readable storage medium, the computer program comprising program code for controlling a process to execute a process, the process comprising providing a reference signal, for use in determining timing of physical random access channel resources, wherein the transmission of the reference signal is indicative of the availability of the physical random access channel resources and receiving, from a user device, transmission of a physical random access signal using the physical random access channel resources.

The process may comprise providing physical random access channel configuration information to the user device.

The physical random access channel configuration information may comprise at least one of frequency information and preamble sequence information.

The process may comprise providing information indicating the relation between the timing of the reference signal and the timing of physical random access channel resources.

The process may comprise receiving transmission of the physical random access signal in dependence on the outcome of a clear channel assessment procedure.

The process may comprise receiving transmission of the physical random access signal without performing a clear channel assessment procedure.

The process may comprise providing an indication to the user device to perform a clear channel assessment procedure.

The process may comprise causing transmission of a second reference signal and receiving the transmission of the physical random access signal after causing transmission of the second reference signal.

The reference signal may be a discovery reference signal.

The physical random access signal may be a physical random access channel preamble.

In a ninth aspect there is provided a computer program product for a computer, comprising software code portions for performing the steps the method of the first aspect and/or second when said product is run on the computer.

In a tenth aspect there is provided a mobile communications system comprising at least one access node and at least one user equipment, wherein the transmission of the reference signal in a cell of the access node is indicative of the availability of the physical random access channel resources in the cell to the user equipment.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a base station and a plurality of communication devices;

FIG. 2 shows a schematic diagram of an example mobile communication device;

FIG. 3 shows an example method of providing PRACH resources for initial access;

FIG. 4 shows an example method of providing PRACH resources for initial access;

FIG. 5 shows a schematic diagram of example resources used for DRS and PRACH;

FIG. 6 shows a schematic diagram of an example control apparatus;

### DETAILED DESCRIPTION

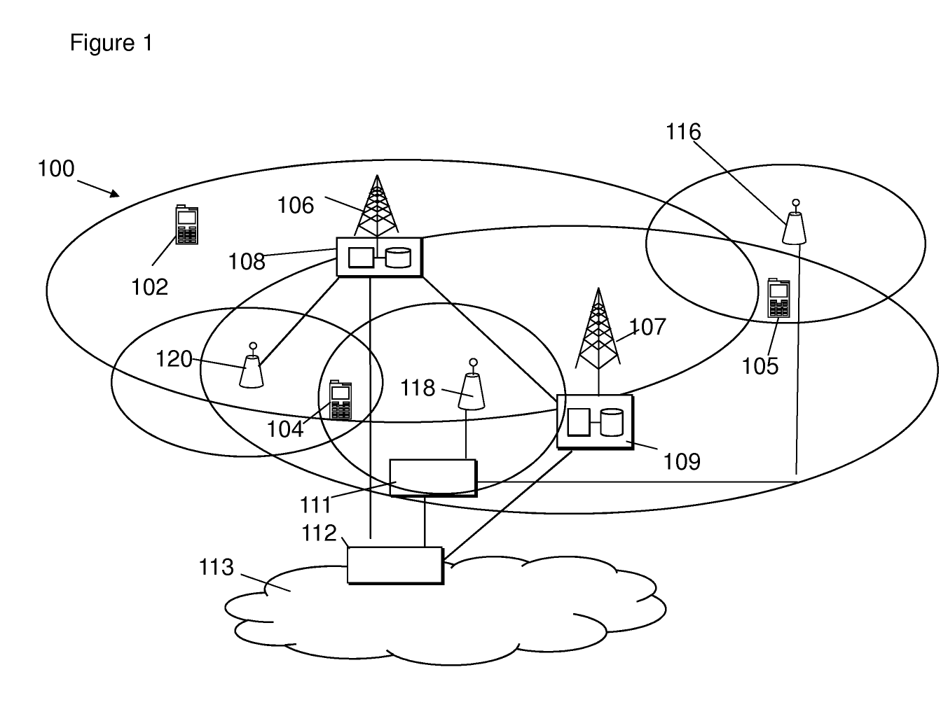

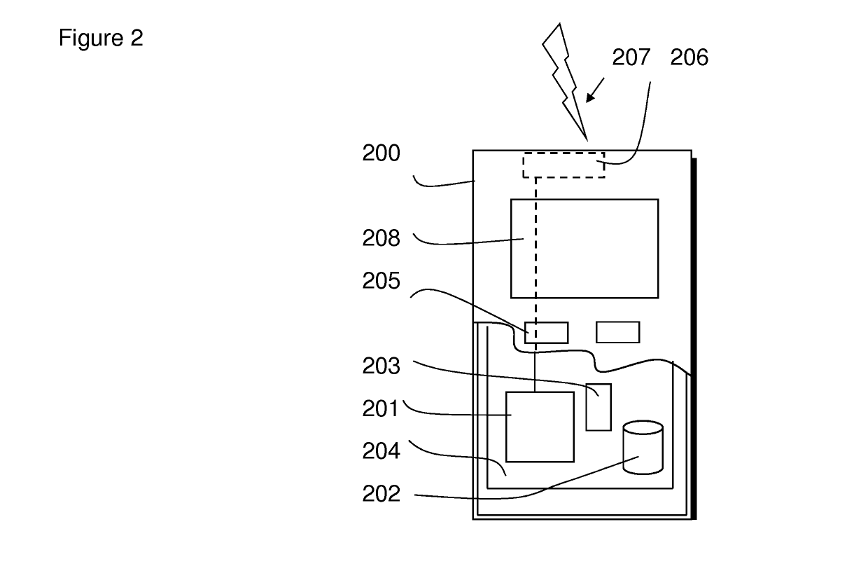

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, mobile communication devices or user equipment (UE) 102, 104, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example WLAN and may be WLAN APs.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on. Signaling mechanisms and procedures, which may enable a device to address in-device coexistence (IDC) issues caused by multiple transceivers, may be provided with help from the LTE network. The multiple transceivers may be configured for providing radio access to different radio technologies.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as wireless local area network (WLAN) and/or WiMax (Worldwide Interoperability for Microwave Access). A base station can provide coverage for an entire cell or similar radio service area.

Wireless communication systems may be licensed to operate in particular spectrum bands. A technology, for example LTE, may operate, in addition to a licensed band, in an unlicensed band. Operating using LTE in an unlicensed band may be referred to as LTE-U. One proposal for operating in unlicensed spectrum is Licensed-Assisted Access (LAA). LTE-LAA may imply that a connection to a licensed band is maintained while using the unlicensed band. Moreover, the licensed and unlicensed bands may be operated together using, e.g., carrier aggregation or dual connectivity. For example, carrier aggregation between primary cell (PCell) on a licensed band and one or more secondary cells (SCells) on unlicensed band may be applied. In an alternative proposal stand-alone operation using unlicensed carrier only may be used.

In some jurisdictions, unlicensed technologies may need to abide by certain regulations, e.g. Listen-Before-Talk (LBT), in order to provide fair coexistence between LTE and other technologies such as Wi-Fi as well as between LTE operators.

In LTE-U, before being permitted to transmit, a user or an access point (such as eNodeB) may, depending on regulatory requirements, need to monitor a given radio frequency, i.e. carrier, for a short period of time to ensure the spectrum is not already occupied by some other transmission. This requirement is referred to as Listen-Before-Talk (LBT). The requirements for LBT vary depending on the geographic region: e.g. in the US such requirements do not exist, whereas in e.g. Europe and Japan the network elements operating on unlicensed bands need to comply with LBT requirements. Moreover, LBT may be needed in order to guarantee co-existence with other unlicensed band usage in order to enable e.g. fair co-existence with Wi-Fi also operating on the same spectrum and/or carriers.

The following relates to assignment of physical random access channel (PRACH) resources with regard to timing association. Embodiments may in particular be used during standalone operation of LTE in unlicensed spectrum, which represents an evolution of currently discussed Licensed Assisted Access (LAA) using LTE. In standalone operation at least some of the functions for access to cells on unlicensed spectrum and data transmission in these cells are performed without or with only minimum assistance or signaling support from licensed-based spectrum.

With LAA, LTE operation in the unlicensed spectrum is based on the LTE Carrier Aggregation (CA) framework where one or more low power secondary cells (SCells) operates in the unlicensed spectrum and may be either DL-only or contain both UL and DL, and where the primary cell (PCell) operates in the licensed spectrum and can be either LTE FDD or LTE TDD in accordance with the scope of the Rel-13 study item on Licensed Assisted Access (LAA).

As described above, LAA may be based on a CA framework where cells in the unlicensed spectrum are operated as SCells. Therefore physical random access channel (PRACH) and random access (RA) procedure in unlicensed spectrum has been considered in the context of CA with licensed spectrum. Specifically, in the context of CA with licensed spectrum, random access in LAA SCells is only needed for supporting uplink timing advance in unlicensed spectrum. With LAA, RA for initial access is always performed in the licensed spectrum.

Since LAA cells in unlicensed spectrum can only be operated as SCell, random access procedure in LAA cells is only needed for deriving timing information for uplink transmissions in unlicensed spectrum and only contention free random access is supported on LAA cells (if the eNB decides that RA is needed), and the handling of preamble transmission dropping from Rel-12 Dual Connectivity is used as baseline for preamble dropping on LAA carriers due to LBT (listen-before-talk) failure (if the UE is required to perform LBT before UL transmission).

Physical random access channel (PRACH) and corresponding resource mapping for initial access using unlicensed spectrum has not been considered.

In particular, for standalone LTE operation in unlicensed spectrum it may be needed to provide physical random access channel resources to UE for initial access in unlicensed spectrum. It should be noted that these resources are accessible on a contention basis. That is, multiple UEs may try to access the resources at the same time, and in some instances, no UEs will try to access these resources.

As considered in prior art solutions for PRACH on LAA SCells, using UL resources (UL subframes and/or special subframes) derived from the UL/DL configuration indicated to the UE is a possibility. However, it may be desirable to consider how a user requesting initial access (i.e. in absence of a PCell in licensed spectrum) can derive the timing information necessary for a correct identification of the PRACH resources. With prior art solutions such timing information may be provided as part of the system information, and it is assumed that the UE is already time synchronized and aware of the UUDL configuration used on the corresponding cell in unlicensed spectrum. The UE may derive the information needed for initiating transmission on PRACH as a combination of information embedded in the DRS (which may also include system information) and specification based rules. The information of the PRACH resources would indicate frequency offset, spreading, interlacing and cover codes. This information may be indicated as one or more sequences to use at the UE's discretion.

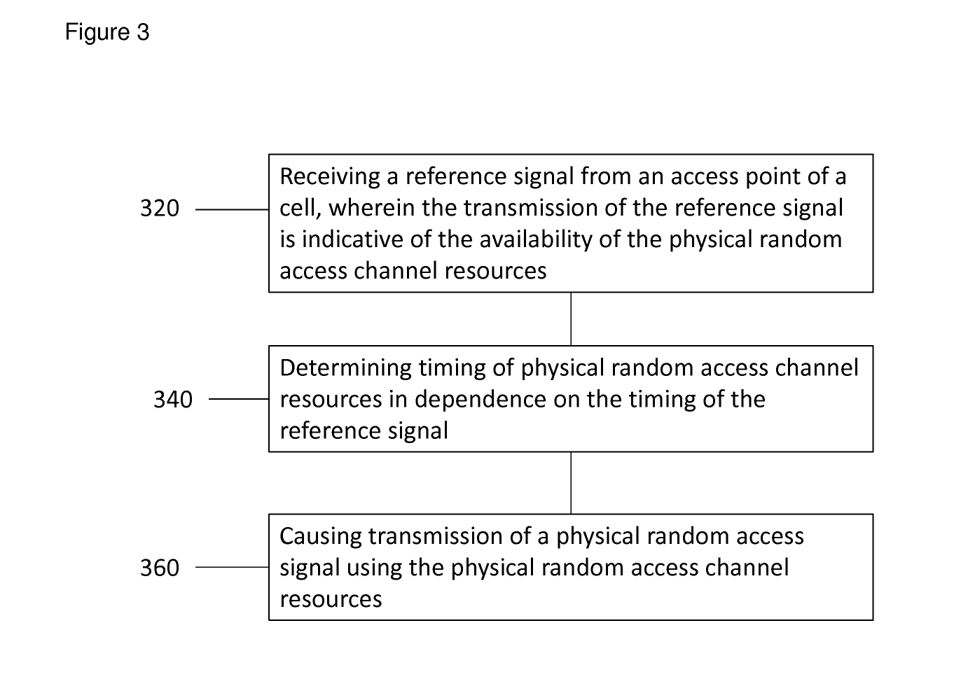

FIG. 3 shows a flowchart of an example method of providing a PRACH configuration for standalone LTE operation in unlicensed spectrum, which can be used to provide initial access functionality to users operating in a standalone LTE on unlicensed (LTE-U) network.

In a first step 320, the method comprises receiving a reference signal from an access point of a cell wherein the transmission of the reference signal is indicative of the availability of the physical random access channel resources.

In a second step 340, the method comprises determining timing of physical random access channel resources in dependence on the timing of the reference signal.

In a third step 360, the method comprises causing transmission of a physical random access signal, such as a PRACH preamble, using the physical random access channel resources.

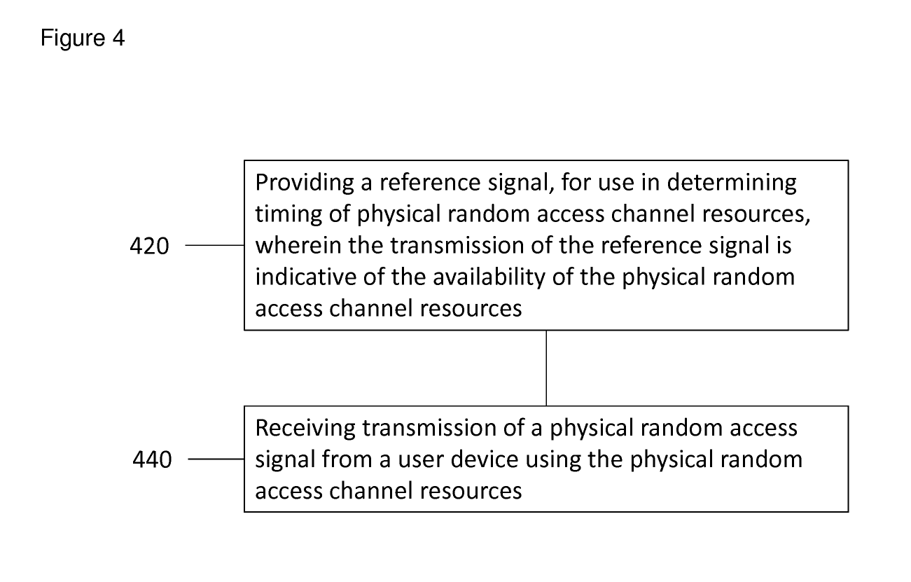

FIG. 4 shows an example method a flowchart of an example method of providing a PRACH configuration for standalone LTE operation in unlicensed spectrum, which can be used to provide initial access functionality to users operating in a standalone LTE on unlicensed (LTE-U) network.

The method comprises, in a first step 420, providing a reference signal, wherein the transmission of the reference signal is indicative of the availability of the physical random access channel resources, for use in determining timing of physical random access channel resources.

In a second step 440, the method comprises receiving transmission of a physical random access signal, such as a PRACH preamble, from a user device using the physical random access channel resources.

The reference signals may be discovery reference signals (DRS). The method for configuring PRACH resources in unlicensed spectrum may thus be linked to the transmissions of discovery reference signals (DRS) which may also include system information, and is tailored for initial access in unlicensed spectrum. In 3GPP Rel-12, DRS were designed to support small cell on/off where SCells that are not activated for any UEs may be turned off except for periodic transmissions of DRS. The transmissions of DRS occur in DRS occasions that may have a periodicity of for example 40, 80 or 160 ms. The signals comprising the DRS may comprise the primary synchronisation signal (PSS), secondary synchronisation signal (SSS), cell specific reference signals (CRS) and the channel state information reference signal (CSI-RS).

Determining the timing of PRACH resources may comprise deriving the timing of the physical random access resources (e.g. PRACH) used by a UE for initial access in cell in unlicensed spectrum from the timing of the discovery reference signals (DRS) transmitted on the corresponding unlicensed cell.

By deriving the transmission timing from the DRS transmission, the user equipment may also be able to determine whether the DRS is being transmitted from the eNB and thereby determine whether associated PRACH resources exist.

When transmitting on the DRS associated PRACH resources there is a possibility for the UE to cause transmission of PRACH signals without assessing whether the radio channel is clear for transmission in the uplink. Due to timing restrictions related to this operation, transmission using the determined PRACH resources may be allowed only once per DRS transmission.

The method may comprise receiving information indicating the relation between the timing of the reference signal and the timing of the physical random access channel resources. For example, the timing relation between DRS and PRACH time resources may be signaled to the UE as part of the system information. Alternatively, or in addition, the timing relation between DRS and PRACH time resources may be defined by standardization or otherwise.

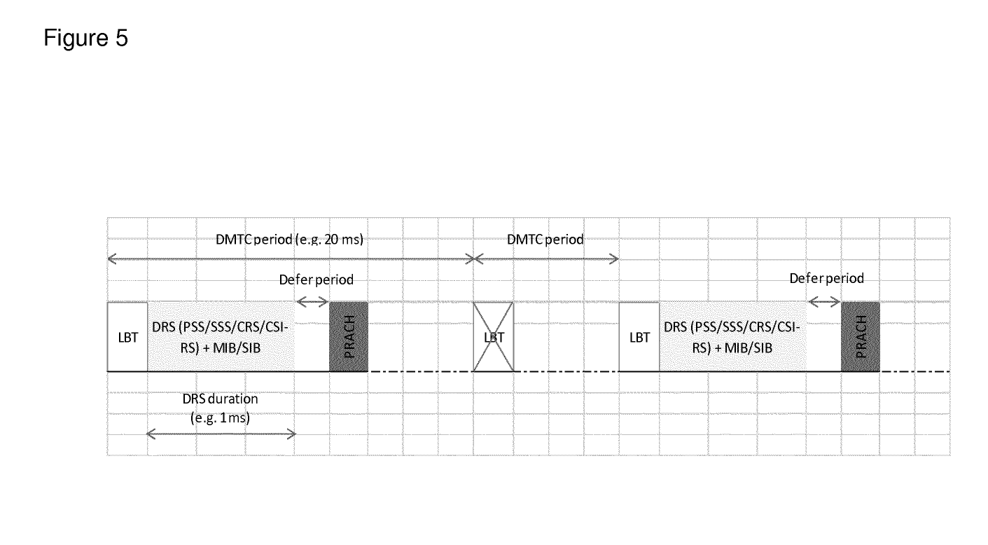

A relation between the DRS timing and PRACH timing is illustrated in FIG. 5. In the example in FIG. 5 the timing is relative to the end of the DRS transmission, and is labelled as “defer period”. This corresponds to an embodiment where the time elapsing between the end of DRS transmission and the start of PRACH is shorter than (or equal to) the defer period of the clear channel access procedure (i.e. the minimum time a device has to sense the channel as free before it can start transmitting on it). Then transmission on PRACH can actually take place without clear channel assessment procedure at the UE. The DRS transmissions (which may comprise PSS, SSS, CRS, CSI-RS and system information) occur once per discovery measurement timing configuration (DMTC). DRS transmission is subject to clear channel assessment/listen-before-talk, i.e. DRS transmission may be postponed or even dropped within a certain DMTC period. In the latter case, also PRACH resources would not be available in the corresponding DMTC period.

UL transmission using PRACH resources may or may not be subject to LBT in the UE.

An access point may provide an indication to a user device to perform a clear channel assessment procedure, i.e. whether to use LBT or not. Alternatively, or in addition, the UE may determine whether CCA, e.g. LBT is required based on the DRS timing information and/or regulations. In one embodiment, the UL transmission in PRACH resources may not be subject to LBT if e.g. extended CCA (clear channel assessment) is applied at the eNB before DRS transmission and/or if the time between DRS and PRACH is less than or equal to a predetermined value, which would prevent other devices seeing the corresponding channel as being free and as a consequence starting transmission. In some implementations, this predetermined values is set to 16 microseconds, but may take other values for other implementations. With such an implementation of a short gap between eNB transmission and UE transmission, the PRACH resources may be considered as part of same transmission opportunity as the DRS transmission such that no LBT check by the UE is needed for sending the random access signal on PRACH (e.g. RACH preamble),. It should be noted that since the eNB and the UE share the same physical resources, embodiments may be applicable for TDD (time domain duplexing) based systems.

In another possible implementation, UL transmission using PRACH resources may be subject to LBT in the UE.

The method may comprise receiving physical random access channel configuration information, e.g. amongst others, frequency and preamble sequence. Additional information on the PRACH configuration (frequency, preamble sequence, etc.) may be signaled to the UE as part of the system information that may be broadcast during DRS subframes.

In an example embodiment, the UE derives information on the PRACH configuration from the system information. Then the UE (and the eNB) derives PRACH timing from the timing of DRS transmission, and uses the obtained timing information to start the physical layer random access procedure by transmitting a specific preamble using specific frequency resources at the given timing. If the system information is transmitted together with DRS, the UE may not have enough time to process system information and perform RACH within the same DRS cycle. In this case UE may perform random access after the next DRS transmission.

Alternatively, or in addition, a UE may first acquire time synchronization and system information including UL/DL configuration and information on the resources to be used for PRACH. The UE may then perform random access in UL using the PRACH resources derived from the UL/DL configuration indicated to the UE (if PRACH resources are configured). However, if no PRACH resources are configured in the UL/DL configuration signaled by the eNB, the UE may derive the exact timing of the PRACH resources based on a method such as that shown in FIGS. 3 and 4 (in current or next DRS transmission). That is, in one embodiment, the UE may autonomously select between the configured PRACH resources and the DRS-associated PRACH resources.

In one embodiment, the eNB may use two different distinct DRS configurations to indicate to the UE whether or not the UE should be applying LBT before its uplink transmission on PRACH.

In yet another embodiment, the eNB may use additional signaling on top of the DRS to indicate the timing and availability of the PRACH resources.

In yet another embodiment the eNB may provide multiple UL time instants for the UEs to transmit the PRACH, and for this case, the eNB may guarantee that other uplink resources are being assigned to other UEs to maintain the reservation of the radio channel. In such an embodiment, the eNB would experience too little capacity for PRACH resources to be contained within a single transmission instant, and to expand the PRACH resources, the eNB would reserve more PRACH resources in following transmission instant. However, UEs using such additional PRACH resources may be mandated to use clear channel assessment procedures. It should be noted that in case of device to device operation, one UE may also be transmitting DRS allowing for instant access by another neighboring UE.

The UE may start transmission of random access preamble without necessarily knowing the UL/DL configuration used in the corresponding unlicensed cell. This may enable faster random access procedure.

In some embodiments, the availability of the PRACH resources for initial access would be provided through system information like operation, where the exact timing and physical resources are provided as persistent or reserved resources.

In other embodiments the availability of the PRACH resources for initial access may be entirely coupled to the availability of the DRS, such that the UE is only allowed to use the associated PRACH resources in case the DRS for this instant is detected.

In yet another embodiment, the two previous approaches are combined such that a hybrid between the two is obtained.

While applying the previous embodiments, the network may facilitate a solution where PRACH resources for initial access are provided as part of the DRS (and system information) configuration and do not require the configuration of specific UL resources (subframes), which may result in undesirable overhead, as such configured UL subframes are non-flexible in nature and committed to UL transmission. Such UL subframes cannot be reassigned to DL transmissions, and will reduce the overall flexibility of the system. Further, the reduced flexibility may create some unwanted interference situations between different nodes in the system. This applies to any combination of eNB to eNB, eNB to UE, UE to eNB and UE to UE interference.

With the proposed idea eNB can control the frequency of availability of PRACH resources (based on the need) kind of dynamically by increasing the DRS transmission rate (no need to change SIB).

It should be understood that each block of the flowchart of the Figures and any combination thereof may be implemented by various means or their combinations, such as hardware, software, firmware, one or more processors and/or circuitry.

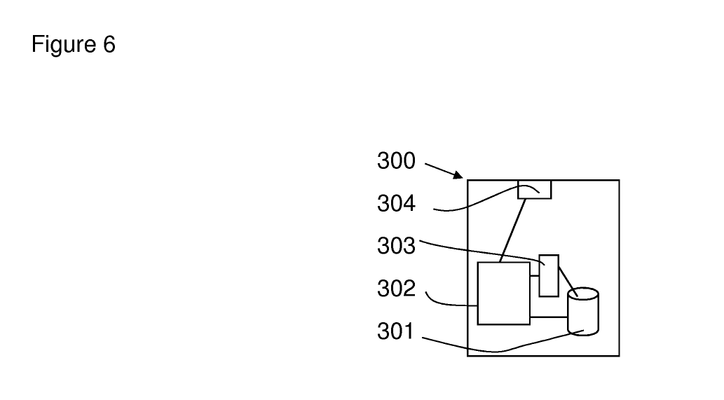

The method may be implemented on a mobile device as described with respect to FIG. 2 or control apparatus as shown in FIG. 6. FIG. 6 shows an example of a control apparatus for a communication system, for example to be coupled to and/or for controlling a station of an access system, such as a RAN node, e.g. a base station, (e) node B or 5G AP, a central unit of a cloud architecture or a node of a core network such as an MME or S-GW, a scheduling entity, or a server or host. The method may be implanted in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the control apparatus 300 can be configured to execute an appropriate software code to provide the control functions. Control functions may comprise providing a reference signal, for use in determining timing of physical random access channel resources, wherein the transmission of the reference signal is indicative of the availability of the physical random access channel resources and receiving transmission of a physical random access signal from a user device using the physical random access channel resources.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to LTE networks, similar principles maybe applied in relation to other networks and communication systems, for example, 5G networks. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1-25. (canceled)

26. A method, comprising:
receiving a reference signal from an access point of a cell, wherein the transmission of the reference signal is indicative of the availability of the physical random access channel resources;
determining timing of physical random access channel resources in dependence on the timing of the reference signal; and
causing transmission of a physical random access signal using the physical random access channel resources.

27. A method according to claim 26, comprising receiving physical random access channel configuration information.

28. A method according to claim 27, wherein the physical random access channel configuration information comprises at least one of frequency information and preamble sequence information.

29. A method according claim 26, comprising receiving information indicating the relation between the timing of the reference signal and the timing of physical random access channel resources.

30. A method according to claim 26, comprising causing the transmission of the physical random access signal in dependence on the outcome of a clear channel assessment procedure.

31. A method according to claim 26, comprising causing transmission of the physical random access signal without performing a clear channel assessment procedure.

32. A method according to claim 26, comprising receiving a second reference signal and causing the transmission of the physical random access signal after receipt of the second reference signal.

33. A method according claim 26, wherein the reference signal comprises a discovery reference signal.

34. A method according to claim 26, wherein the physical random access signal comprises a physical random access channel preamble.

35. A method comprising:
providing a reference signal, for use in determining timing of physical random access channel resources, wherein the transmission of the reference signal is indicative of the availability of the physical random access channel resources; and
receiving, from a user device, transmission of a physical random access signal using the physical random access channel resources.

36. A method according to claim 35, comprising providing physical random access channel configuration information to the user device.

37. A method according to claim 36, wherein the physical random access channel configuration information comprises at least one of frequency information and preamble sequence information.

38. A method according to claim 36, comprising providing information indicating the relation between the timing of the reference signal and the timing of physical random access channel resources.

39. A computer program product embodied on a non-transitory computer-readable medium, said product comprising software code portions for performing the steps of claim 26 when said product is run on the computer.

40. An apparatus, comprising:
at least one processor; and
at least one memory including a computer program code, the at least one memory and the computer program code configured to, with the at least one processor, cause the apparatus at least to:
receive a reference signal from an access point of a cell, wherein the transmission of the reference signal is indicative of the availability of the physical random access channel resources;
determine timing of physical random access channel resources in dependence on the timing of the reference signal; and
cause transmission of a physical random access signal using the physical random access channel resources.

41. An apparatus, comprising:
at least one processor; and
at least one memory including a computer program code, the at least one memory and the computer program code configured to, with the at least one processor, cause the apparatus at least to:
provide a reference signal, for use in determining timing of physical random access channel resources, wherein the transmission of the reference signal is indicative of the availability of the physical random access channel resources; and
receive, from a user device, transmission of a physical random access channel signal using the physical random access channel resources.

42. A method according to claim 29, comprising causing the transmission of the physical random access signal in dependence on the outcome of a clear channel assessment procedure.

43. A method according to claim 29, comprising causing transmission of the physical random access signal without performing a clear channel assessment procedure.

44. A computer program product embodied on a non-transitory computer-readable medium, said product comprising software code portions for performing the steps of claim 36 when said product is run on the computer.
